(19) United States
(12) Patent Application Publication
(10) Pub. No.: US 2009/0291609 A1
(43) Pub. Date: Nov. 26, 2009

(54) Method of manufacturing plasma display device and plasma display device made by this method

(76) Inventor: Hyuk Kim, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/453,695

(22) Filed: May 19, 2009

(30) Foreign Application Priority Data
May 20, 2008 (KR) KR10-2008-0046529

(51) Int. Cl. H01J 9/00

(52) U.S. Cl. 445/24

(57) ABSTRACT

A method of manufacturing a plasma display device and a plasma display device made by this method are taught. In the plasma display device, the adhesion rate between a graphite layer and a plasma display panel is increased, therefore, the performance of the heat dissipation may be enhanced, the noises may be reduced, and the afterimages may be prevented, and the procedural steps of manufacture and the costs of making the graphite layer may be reduced. The method contemplates a first panel preparing step performed by preparing a first panel; a graphite layer forming step performed by coating a liquid graphite material on the first panel using a coating apparatus, and hardening the coated liquid graphite; and a chassis base adhering step performed by adhering a chassis base on the first panel with the chassis base facing to the graphite layer disposed on the plasma display panel.

### CLAIM OF PRIORITY

This application makes reference to, incorporates the same herein, and claims all benefits accruing under 35 U.S.C. §119 from an application earlier filed in the Korean Intellectual Property Office on 20 May 2008 and there duly assigned Serial No. 10-2008-0046529.

### BACKGROUND OF THE INVENTION

1. Field of the Invention

An embodiment of the present invention relates to a method of making a plasma display device and a plasma display device made by this method.

2. Description of the Related Art

A plasma display device is a flat panel display device for displaying variable visual characters and/or images, such as moving images corresponding to a video signal, using the plasma produced by the gas discharge.

In the plasma display device, heat is generally generated in a plasma display panel of the plasma display device due to the high temperature of the discharged gas. Furthermore, when the degree of gas discharge is increased in order to enhance the luminance of the plasma display device, more heat may be generated in the plasma display panel.

In the plasma display device, it is therefore important to effectively dissipate the heat which is generated from the plasma display panel in order to guarantee a smooth operation of the plasma display device.

### SUMMARY OF THE INVENTION

It is therefore an aspect of the present invention to provide a method of making a plasma display device and a plasma display device made by this method in order to solve the aforementioned problems such as the nonuniform distribution of the temperature throughout a plasma display panel of the plasma display device and the high costs of manufacture of the plasma display device.

It is another aspect of the present invention to provide a method of making a plasma display device with lower costs of the manufacture, and a plasma display device made by this method with the plasma display device efficiently dissipating the heat generated from a plasma display panel of the plasma display device.

It is still another aspect of the present invention to provide a method of making a plasma display device and a plasma display device made by this method, and in the plasma display device, the rate of adhesion between a graphite layer and the plasma display panel is increased, therefore, the performance of the heat dissipation may be enhanced, noises may be reduced, afterimages may be prevented, and procedural steps of the manufacture and costs of the graphite layer may be reduced.

According to an aspect of the present invention, a method of manufacturing a plasma display device, contemplates a first panel preparing step performed by preparing a first panel; a graphite layer forming step performed by coating a liquid graphite material on the first panel using a coating apparatus, and hardening the coated liquid graphite; and a chassis base adhering step performed by adhering a chassis base on the first panel with the chassis base being opposite to and facing to the graphite layer disposed on the first panel.

According to another aspect of the present invention, a plasma display device, includes a plasma display panel being formed by bonding first and second panels together; a graphite layer being formed on a first surface of the first panel, with the first surface of the first panel being opposite to a second surface of the first panel, and with the second surface being disposed to face to the second panel; a chassis base being adhered to the first panel, with the chassis base being spaced apart from and facing to the graphite layer; a driving circuit being mounted on a first surface of the chassis base, with the first surface of the chassis base being opposite to a second surface of the chassis base, and with the second surface of the chassis base being a surface where the first panel is adhered; and the graphite layer being formed by coating a liquid graphite material on the first surface of the first panel.

In the aforementioned method of manufacture of the plasma display device and the plasma display device made of this method, the performance of the heat dissipation, the performance of the noise reduction and the performance of the image-sticking prevention may be enhanced, and the costs of manufacture of the plasma display device may be reduced.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a flowchart illustrating a method of manufacturing a plasma display device constructed as one embodiment of the present invention;

FIGS. 2A to 2D are schematic perspective views showing the procedural steps of the method for manufacturing the plasma display device constructed as the one embodiment of the present invention;

FIG. 3 illustrates schematic plan views of a plasma display panel showing different experimental temperature distributions of a plasma display panel in dependence upon different rates of adhesion between the plasma display panel and a graphite layer;

FIG. 4 is a schematic perspective view illustrating a method of coating a graphite material during the manufacture of a plasma display device constructed as another embodiment of the present invention;

FIG. 5 is a schematic perspective view illustrating a method of coating a graphite material during the manufacture of a plasma display device constructed as still another embodiment of the present invention; and

FIG. 6 is a schematic perspective view illustrating a method of coating a graphite material during the manufacture of a plasma display device constructed as yet another embodiment of the present invention.

### DETAILED DESCRIPTION OF THE INVENTION

Common reference numerals are used throughout the drawings and the detailed description in order to indicate the same elements. Hereinafter, several embodiments of the present invention will be described in detail with reference to the accompanying drawings.

In a contemporary plasma display device, in order to enhance the efficiency of the heat dissipation in the plasma display device, the mounting state of a heat dissipation sheet adhered to the plasma display panel is important. That is, when the heat dissipation sheet completely adheres to a plasma display panel, the heat may be well thermally conducted through the heat dissipation sheet, and thus the efficiency of the heat dissipation may be enhanced.

Since the heat dissipation sheet used in the contemporary plasma display device is normally manually adhered to a plasma display panel, it is exactly tedious and extremely difficult to perfectly adhere the heat dissipation sheet to the plasma display panel.

Additionally, the heat dissipation sheet used in the contemporary plasma display device may significantly increase the costs incurred during the manufacture of the plasma display panels due to the high costs of the sheet processing procedures.

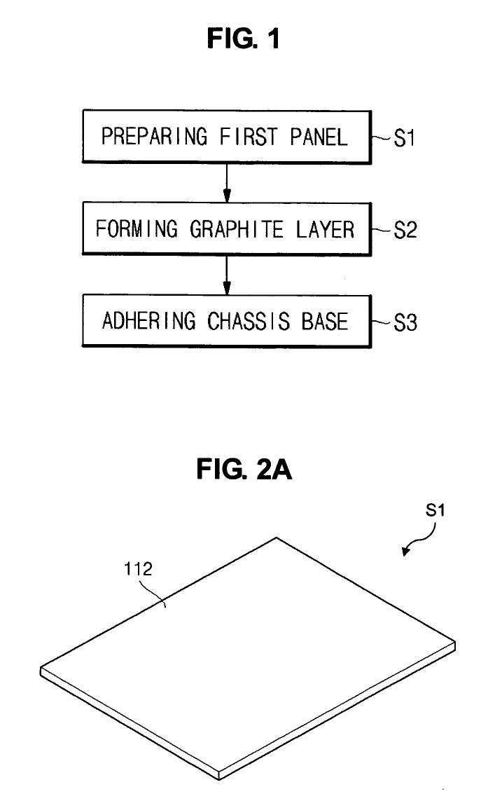

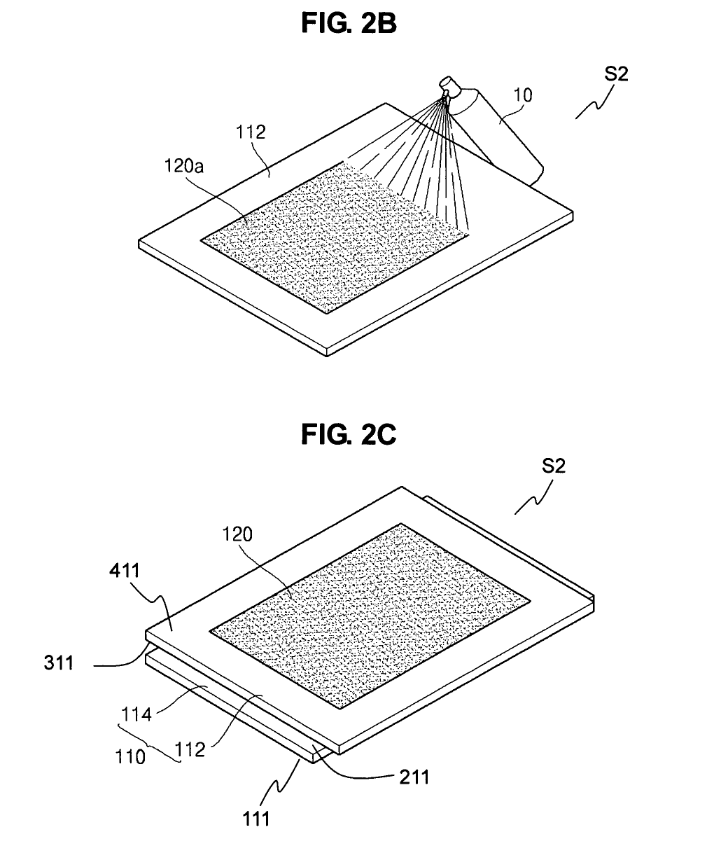

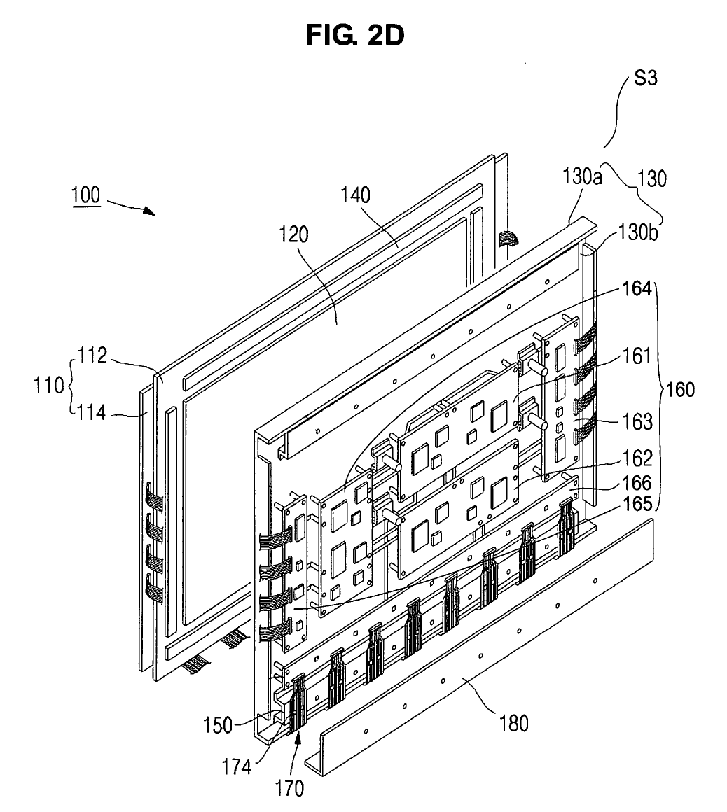

FIG. 1 is a flowchart showing a method of manufacturing a plasma display device constructed as one embodiment of the present invention; and FIGS. 2A to 2D are perspective views showing the procedural steps of the method of manufacturing the plasma display device constructed as the one embodiment of the present invention.

Referring to FIG. 1, the method of manufacturing a plasma display device constructed as the one embodiment of the present invention includes a first panel preparing step (S1), a graphite layer forming step (S2) and a chassis base adhering step (S3).

Referring to FIG. 2A, the first panel preparing step (S1) is performed by preparing a first panel 112.

The first panel 112 has address electrodes (not shown), to which a voltage required for gas discharge in the plasma display device is applied, formed on the first panel 112. Even through not shown in FIG. 2A, a barrier wall, a phosphor, a dielectric and a protective layer may be formed on a surface of the first panel 112 having the address electrodes formed thereon.

Referring to FIGS. 2B and 2C, the graphite layer forming step (S2) is performed by coating liquid graphite material 120a on the first panel 112, thereby forming graphite layer 120.

As shown in FIG. 2B, liquid graphite material 120a is sprayed onto the first panel 112 using sprayer 10. In this case, the step of spraying of liquid graphite material 120a is performed on surface 411 of the first panel 112 with surface 411 being opposite to surface 311 of the first panel 112, and surface 311 is the surface where the address electrode is formed.

Liquid graphite material 120a sprayed onto the first panel 112 is hardened for forming graphite layer 120 on the first panel 112 as shown in FIG. 2C. Here, liquid graphite material 120a may be hardened naturally or hardened in a shortened period of time by adding a separate hardening agent. Since graphite layer 120, as formed by the above mentioned methods, has a higher thermal conductivity compared to another heat dissipation member, e.g., a silicon layer, it is advantageous to use such graphite layer 120 for enhancing the efficiency of the heat dissipation. Graphite layer 120 is generally constructed as a heat dissipation layer.

Meanwhile, the graphite layer forming step (S2) includes a procedural step of bonding the first panel 112 having graphite layer 120 formed thereon and a second panel 114 together, thereby forming a plasma display panel 110.

The second panel 114 is a panel on which images are substantially displayed. Display electrodes, to which a voltage required for gas discharge in the plasma display device is applied, and a dielectric layer (not shown) may be formed on surface 211 of the second panel 114 opposite to surface 111 of the second panel 114 on which images are displayed, i.e., surface 211 of the second panel 114 opposite and facing to the first panel 112.

The bonding of the first and second panels 112 and 114 is performed using a sealant (not shown) such that surface 211 of the second panel 114 having the display electrodes formed thereon is oriented to face surface 311 of the first panel 112 having the address electrodes formed thereon. Accordingly, when the first and second panels 112 and 114 are bonded together, the address electrodes of the first panel 112 and the display electrodes of the second panel 114 may constitute discharge cells in plasma display panel 110.

Even though the process of bonding the first and second panels 112 and 114 is included in the graphite forming step (S2) in the embodiment of the present invention, it may be alternatively included in the first panel preparing step (S1). In this case, the first panel 112 and the second panel 114 may be firstly bonded in the first panel preparing step (S1), and then graphite layer 120 is formed on the first panel 112 in the graphite forming step (S2).

As described above, when liquid graphite material 120a is coated on the first panel 112 using sprayer 10 that is a separate coating apparatus so as to form graphite layer 120, the likelihood that air gaps may occur between the first panel 112 and graphite layer 120 may be reduced.

Accordingly, the rate of adhesion between the first panel 112 and graphite layer 120 may be increased by coating liquid graphite material 120a on the first panel 112 using a coating means, for example, using the sprayer, compared to the rate of adhesion between the first panel 112 and graphite layer 120 when graphite layer 120 is formed on the first panel 112 using conventional manual procedures.

Referring to FIG. 2D, the chassis base adhering step (S3) is a step of adhering chassis base 130 to the first panel 112 with adhering chassis base 130 facing to graphite layer 120, therefore, plasma display device 100 is assembled.

Chassis base 130 is adhered to graphite layer 120 using adhesive member 140 in order to support plasma display panel 110 and dissipate the heat generated from plasma display panel 110. Chassis base 130 may be formed of a metallic material with high thermal conductivity, for example, aluminum and aluminum alloys. The material forming chassis base 130 is however not limited thereto. Specifically, chassis base 130 includes a front surface 130a and a rear surface 130b. Front surface 130a of chassis base 130 is a surface faced to graphite layer 120, and rear surface 130b of chassis base 130 is a surface where reinforcing member 150 and driving circuit 160 are mounted. Reinforcing member 150 and driving circuit 160 will be described later.

Adhesive member 140 formed in a stripe frame shape is disposed at an edge of graphite layer 120 in order to physically fix plasma display panel 110 to chassis base 130. An adhesive, an adhesive sheet, a stripe with adhesive disposed on both sides and an adhesive tape may be used as adhesive member 140. The adhering method, thickness and shape of adhesive member 140 may vary in dependence upon the characteristics of chassis base 130.

Reinforcing member 150 is mounted on rear surface 130b of chassis base 130 for preventing chassis base 130 from being bent or being deformed. When reinforcing member 150 is formed to be in physical contact with signal transmission conductor 170, reinforcing member 150 also serves as a heat dissipation member for dissipating the heat generated from signal transmission conductor 170. Signal transmission conductor 170 will be described later. Reinforcing member 150 may be formed of a metallic material. Preferably, reinforcing member 150 may be formed of a metallic material with high thermal conductivity, for example, aluminum and aluminum alloys. The material forming reinforcing member 150 is however not limited thereto. Reinforcing member 150 either may be formed integrally with chassis base 130, or may be manufactured separately from chassis base 130 and then be mounted on rear surface 130b of chassis base 130 by a screw or the like.

Specifically, driving circuit 160 is mounted on rear surface 130b of chassis base 130 by a fastener (not shown) and may be divided into several pieces of boards 161, 162, 163, 164, 165 and 166. That is, driving circuit 160 includes a switch mode power supply (hereinafter, referred to as “SMPS”) 161, logic board 162, sustain driving board 163, scan driving board 164, scan buffer board 165 and logic buffer board 166. Driving chips and other circuit elements required for driving plasma display panel 110 are respectively mounted on each of boards 161, 162, 163, 164, 165 and 166.

Meanwhile, signal transmission conductor 170 for the electrical connection between plasma display panel 110 and driving circuit 160 is provided between plasma display panel 110 and driving circuit 160.

Signal transmission conductor 170 electrically connects sustain driving board 163, scan buffer board 165 and logic buffer board 166 to plasma display panel 110, respectively. Signal transmission conductor 170 respectively transmits driving signals from sustain driving board 163, scan buffer board 165 and logic buffer board 166 to plasma display panel 110. A flexible printed circuit board (FPCB) may be used as signal transmission conductor 170.

Cover plate 180 is provided from an exterior of logic buffer board 166 in order to protect driving chip 174 of signal transmission conductor 170 which electrically connects logic buffer board 166 to plasma display panel 110 from the exterior of logic buffer board 166.

Specifically, cover plate 180 is disposed at an exterior of driving chip 174 of signal transmission conductor 170, and may be bonded to reinforcing member 150 by a fastener (not shown). Cover plate 180 protects driving chip 174 from external impacts and dissipates the heat generated from driving chip 174 to the exterior. Cover plate 180 may be formed of a metallic material with a heat dissipation property and a strength equal to or higher than the predetermined strength, for example, aluminum and aluminum alloys.

In plasma display device 100 made by the aforementioned method, since graphite layer 120 is formed by coating liquid graphite material 120a on first panel 112 using the sprayer that is a separate coating apparatus in stead of using the conventional manual procedures, the air gaps which may be formed between graphite layer 120 and first panel 112 may be reduced, and thus the rate of adhesion between graphite layer 120 and first panel 112 may be increased.

Accordingly, in plasma display device 100, the performance of the heat dissipation may be enhanced such that the heat generated from plasma display panel 110 may be dissipated through graphite layer 120 when plasma display device 100 is driven. Also, in plasma display device 100, the performance of the image sticking prevention may be enhanced such that the image sticking generated due to the temperature increase and the irregular temperature of plasma display panel 110 may be prevented. Also, in plasma display device 100, the performance of the noise reduction may be enhanced such that the noises generated from plasma display panel 110 may be absorbed by graphite layer 120 when plasma display device 100 is driven. Also, in plasma display device 100, graphite layer 120 is formed on the first panel 112 using a raw material of liquid graphite material 120a. For this reason, when a contemporary graphite layer is manufactured in a sheet type and is formed on a panel, the costs of sheet processing and the costs of manufacture of the sheet-type graphite layer may be reduced, and the thickness of graphite layer 120 may be designed to be thin.

As described above, the performance of the heat dissipation, the performance of the noise reduction and the performance of the image-sticking prevention of plasma display device 100 are varied in dependence upon the characteristics of plasma display panel 100, specifically in dependence upon the rate of adhesion between the first panel 112 and graphite layer 120 when plasma display device 100 is driven. A change in the performance of the heat dissipation of plasma display device 100 in dependence upon the rate of adhesion between plasma display panel 110 and graphite layer 120 will be described below.

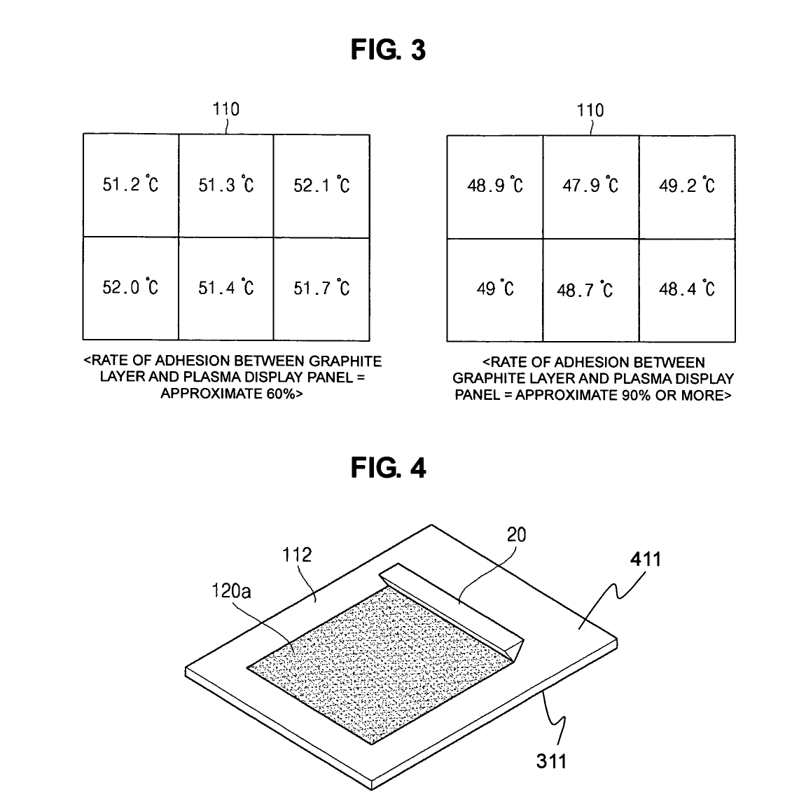

FIG. 3 illustrates schematic plan views of a plasma display panel showing different experimental distributions of the temperature in the plasma display panel in dependence upon different rates of adhesion between the plasma display panel and a graphite layer.

Referring to FIG. 3, in the same driving environment, the distribution of temperature in plasma display panel 110 is measured with different rate of adhesion between graphite layer 120 and the first panel 112 of plasma display panel 110. When the rate of adhesion between graphite layer 120 and the first panel 112 is approximate 90% or above, the average temperature of plasma display panel 110 is lower than the average temperature in plasma display panel 110 when the rate of adhesion between graphite layer 120 and the first panel 112 is approximate 60%. Therefore, when the rate of adhesion between graphite layer 120 and the first panel 112 is higher, the heat dissipation performance of plasma display panel 110 is better enhanced. Here, when graphite layer 120 is formed in a sheet type by conventional manual manufacturing process, the rate of adhesion between graphite layer 120 and the first panel 112 is approximate 60%; and when graphite layer 120 is formed by coating liquid graphite material 120a on the first panel 112 according to the above stated embodiment of the present invention, the rate of adhesion between graphite layer 120 and the first panel 112 is approximate 90% or higher.

Hereinafter, a method of manufacturing a plasma display device constructed as another embodiment of the present invention will be described.

FIG. 4 is a perspective view illustrating a method of coating a graphite material during the manufacture of a plasma display device constructed as another embodiment of the present invention.

The method of manufacturing a plasma display device constructed as the current embodiment of the present invention includes a first panel preparing step (S1), a graphite layer forming step (S12) and a chassis base adhering step (S3).

The method of manufacturing a plasma display device constructed as the current embodiment of the present invention is different from the method of manufacturing a plasma display device according to the previously defined embodiment of the present invention, because the graphite layer forming step S12 is different from the graphite layer forming step S2 as shown in FIG. 1. As shown in FIG. 4, in the graphite layer forming step (S12), liquid graphite material 120a is coated on the first panel 112 using dispenser 20 instead of using sprayer 10 as shown in FIG. 2B. The function and effect of the method of manufacturing a plasma display device according to the current embodiment of the present invention are the same as those of the method of manufacturing a plasma display device according to the previously identified embodiment of the present invention. Accordingly, a flowchart showing the method of manufacturing a plasma display device according to the current embodiment of the present invention and descriptions identical to the method of manufacturing a plasma display device according to the previously mentioned embodiment of the present invention are omitted.

Referring to FIG. 4, in the method of manufacturing a plasma display device according to the current embodiment of the present invention, liquid graphite material 120a may be coated on the first panel 112 by dispenser 20 in graphite layer forming step (S12). In this case, the coating of liquid graphite material 120a is performed on surface 411 of the first panel 112 opposite to surface 311 of the first panel 112 having the address electrodes formed thereon. When liquid graphite material 120a is hardened, graphite layer 120 is formed on the first panel 112.

Hereinafter, a method of manufacturing a plasma display device according to still another embodiment of the present invention will be described.

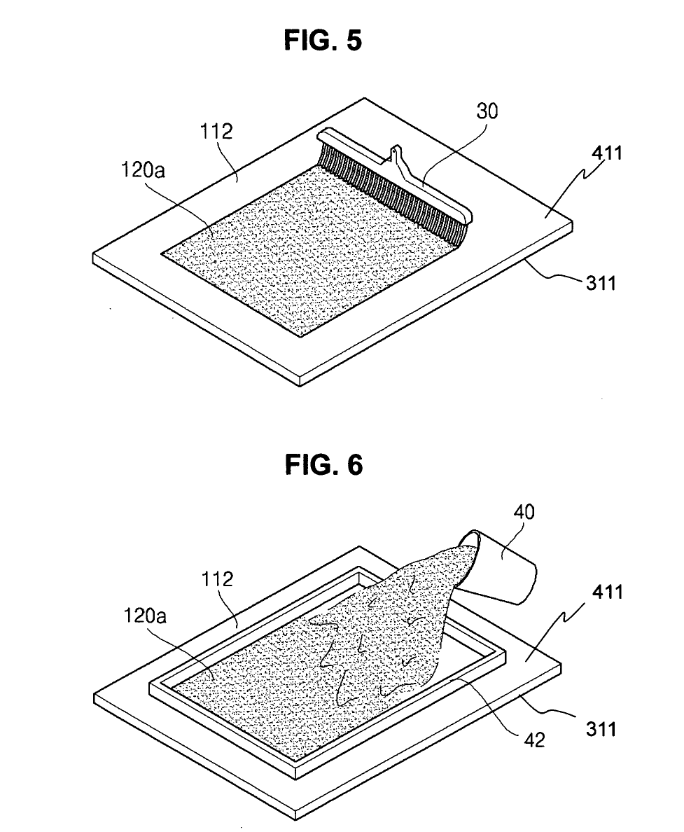

FIG. 5 is a perspective view showing a method of coating a graphite material during the manufacture of a plasma display device according to still another embodiment of the present invention.

The method of manufacturing a plasma display device according to the current embodiment of the present invention includes a first panel preparing step (S1), a graphite layer forming step (S22) and a chassis base adhering step (S3).

The method of manufacturing a plasma display device according to the current embodiment of the present invention is different from the method of manufacturing a plasma display device according to the first embodiment of the present invention, because the graphite layer forming step S22 is different from the graphite layer forming step S2 as shown in FIG. 1. In the graphite layer forming step (S22), liquid graphite material 120a is coated on the first panel 112 using brush 30 instead of using sprayer 10. The function and effect of the method of manufacturing a plasma display device according to the current embodiment of the present invention are the same as those of the method of manufacturing a plasma display device according to the first embodiment of the present invention. Accordingly, a flowchart showing the method of manufacturing a plasma display device according to the current embodiment of the present invention and descriptions identical to the method of manufacturing a plasma display device according to the one embodiment of the present invention are omitted.

Referring to FIG. 5, in the method of manufacturing a plasma display device according to the current embodiment of the present invention, liquid graphite material 120a is coated on the first panel 112 by brush 30 in the graphite layer forming step (S22). In this case, the coating of the liquid graphite material 120a is performed on surface 411 of the first panel 112 opposite to surface 311 of the first panel 112 having the address electrodes formed thereon. When liquid graphite material 120a is hardened, a graphite layer is formed on the first panel 112.

Hereinafter, a method of manufacturing a plasma display device according to yet another embodiment of the present invention will be described.

FIG. 6 is a perspective view showing a method of coating a graphite material in a method of manufacturing a plasma display device according to yet another embodiment of the present invention.

The method of manufacturing a plasma display device according to the current embodiment of the present invention includes a first panel preparing step (S1), a graphite layer forming step (S32) and a chassis base adhering step (S3).

The method of manufacturing a plasma display device according to the current embodiment of the present invention is different from the method of manufacturing a plasma display device according to the one embodiment of the present invention, because the graphite layer forming step S32 is different from the graphite layer forming step S2 as shown in FIG. 1. In the graphite layer forming step (S32), liquid graphite material 120a is coated on the first panel 112 using container 40 for containing liquid graphite material 120a and graphite molding frame 42 instead of using sprayer 10. The function and effect of the method of manufacturing a plasma display device according to the current embodiment of the present invention are the same as those of the method of manufacturing a plasma display device according to the first embodiment of the present invention. Accordingly, a flowchart showing the method of manufacturing a plasma display device according to the current embodiment of the present invention and descriptions identical to the method of manufacturing a plasma display device according to the one embodiment of the present invention are omitted.

Referring to FIG. 6, in the method of manufacturing a plasma display device according to the current embodiment of the present invention, liquid graphite material 120a contained in container 40 for a liquid graphite material is filled into graphite molding frame 42 previously fixed to first panel 112 in the graphite layer forming step (S32). When liquid graphite material 120a is hardened, a graphite layer is formed on the first panel 112. Here, graphite molding frame 42 is positioned on surface 411 of the first panel 112 opposite to surface 311 of the first panel 112 having the address electrodes formed thereon. When liquid graphite material 120a is hardened to form the graphite layer, graphite molding frame 42 is separated and removed from the first panel 112.

According to embodiments of the present invention, in a method of manufacturing a plasma display device and a plasma display device made by this method, a liquid graphite material is coated on a plasma display panel in order to form a graphite layer, thereby increasing the rate of adhesion between the plasma display panel and the graphite layer. Accordingly, when the plasma display device is driven, the heat generated in the plasma display panel may be effectively dissipated, and the noises may be effectively reduced.

Also, according to embodiments of the present invention, in a method of manufacturing a plasma display device and a plasma display device made by this method, the heat generated from a plasma display panel is effectively dissipated. For this reason, the temperature of the plasma display panel is lowered and equalized, thereby reducing the image sticking of the plasma display panel generated due to a high temperature and an irregular temperature of the plasma display panel.

Also, according to embodiments of the present invention, in a method of manufacturing a plasma display device and a plasma display device made by this method, a graphite layer is formed by coating a raw material of a liquid graphite material. Compared to the contemporary graphite layer formed in a sheet type by the sheeting processing method, the method constructed as the embodiments of the present invention may reduce the costs of the sheet processing and the complexity of manufacturing processes for the sheet-type graphite layer.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process, may be implemented by one skilled in the art in view of this disclosure.

What is claimed is:

1. A method of manufacturing a plasma display device, the method comprising the steps of:
a first panel preparing step performed by preparing a first panel;
a heat dissipation layer forming step performed by forming a liquid graphite material on the first panel, and by hardening the coated liquid graphite material in order to form the heat dissipation layer; and
a chassis base adhering step performed by adhering a chassis base on the first panel with the chassis base facing the heat dissipation layer disposed on the first panel.

2. The method of claim 1, with the forming of the liquid graphite material being performed by spraying, using a sprayer, the liquid graphite material onto a first surface of the first panel with the first surface being opposite to a second surface of the first panel, and the second surface being a surface where address electrodes are formed.

3. The method of claim 1, with the forming of the liquid graphite material being performed by coating, using a dispenser, the liquid graphite material onto a first surface of the first panel with the first surface of the first panel being opposite to a second surface of the first panel, and the second surface of the first panel being a surface where address electrodes are formed.

4. The method of claim 1, with the forming of the liquid graphite material being performed by coating, using a brush, the liquid graphite material onto a first surface of the first panel with the first surface of the first panel being opposite to a second surface of the first panel, and the second surface of the first panel being a surface where address electrodes are formed.

5. The method of claim 1, with the forming of the liquid graphite material being performed by the steps of:
fixing a graphite molding frame, for forming the heat dissipation layer, to the first panel; and
filling the liquid graphite material contained in a container into the fixed graphite molding frame.

6. The method of claim 1, with the liquid graphite material further comprising a hardening agent.

7. The method of claim 1, with the heat dissipation layer forming step further comprising a step of:
bonding the first panel and a second panel together in order to form a plasma display panel, with the second panel being bonded to a second surface of the first panel, with the second surface of the first panel being opposite to a first surface of the first panel, and with the first surface of the first panel being a surface where the heat dissipation layer is formed.

8. The method of claim 1, with the first panel preparing step further comprising a step of:
bonding the first panel and a second panel together in order to form a plasma display panel, with the second panel being bonded to a second surface of the first panel, with the second surface opposite to a first surface of the first panel, and with the first surface being a surface where the heat dissipation layer is formed.

9. The method of claim 1, with the chassis base adhering step being performed by adhering the chassis base, where a driving circuit is mounted, to the first panel, with the driving circuit being mounted on a first surface of the chassis base, with the first surface of the chassis base being opposite to a second surface of the chassis base, and with the second surface of the chassis base being the surface where the first panel is adhered.

10. A plasma display device, comprising:
a plasma display panel being formed by bonding first and second panels together;
a heat dissipation layer being formed on a first surface of the first panel, with the first surface of the first panel being opposite to a second surface of the first panel, and with the second surface being disposed to face the second panel;
a chassis base being adhered to the first panel, with the chassis base facing to the heat dissipation layer;
a driving circuit being mounted on a first surface of the chassis base, with the first surface of the chassis base being opposite to a second surface of the chassis base, and with the second surface of the chassis base being a surface where the first panel is adhered; and
the heat dissipation layer comprising a liquid graphite material disposed on the first surface of the first panel.

11. The plasma display device of claim 10, with the liquid graphite material being coated on the first panel using a spray.

12. The plasma display device of claim 10, with the liquid graphite material being coated on the first panel using a dispenser.

13. The plasma display device of claim 10, with the liquid graphite material being coated on the first panel using a brush.

14. The plasma display device of claim 10, with the liquid graphite material being coated on the first panel using a container for containing the liquid graphite material and a graphite molding frame for defining an area, where the liquid graphite material is formed, of the first surface of the first panel.

15. The plasma display device of claim 10, with the liquid graphite material further comprising a hardening agent.

16. The plasma display device of claim 10, with the heat dissipation layer comprising a graphite layer.

17. A plasma display device, comprising:
a plasma display panel having first and second panels with the first and second panels being bonded together; and
a heat dissipation layer being formed on a first surface of the first panel with the first surface of the first panel being opposite to a second surface of the first panel, and the second surface being disposed to face the second panel; and
the heat dissipation layer comprising a hardened liquid graphite material.

18. The plasma display device of claim 17, with the applicator being one selected from:
a sprayer;
a dispenser;
a brush; and
a container for the liquid graphite material and a graphite molding frame for defining an area, where the liquid graphite material is formed, on the first surface of the first panel.

19. The plasma display device of claim 17, with the liquid graphite material further comprising a hardening agent.

20. The plasma display device of claim 17, with the heat dissipation layer comprising a graphite layer.
